(19) United States
(12) Patent Application Publication
(10) Pub. No.: US 2016/0224667 A1
(43) Pub. Date: Aug. 4, 2016

(54) METHOD AND SYSTEM OF IMPLEMENTING AN INTEGRATED INTERFACE SUPPORTING OPERATION IN MULTI-TYPE DATABASES

(71) Applicant: XINYU XINGBANG INFORMATION INDUSTRY CO., LTD., Xinyu City (CN)

(72) Inventor: Xiaohong YAO, Xinyu City (CN)

(21) Appl. No.: 15/008,890

(22) Filed: Jan. 28, 2016

(30) Foreign Application Priority Data
Feb. 4, 2015 (CN) 201510058463.8

(51) Int. Cl. G06F 17/30

(52) U.S. Cl. CPC G06F 17/30864; G06F 17/30477

(57) ABSTRACT

Disclosed is method of implementing an integrated interface supporting operation on multi-type databases. The method comprises creating an integrated interface supporting multi-type data source operations, and implementing functions of the integrated interface through steps to provide application units with a unified access entry to multiple type databases: A) receiving parameter information passed from an application unit; B) finding a target database of the data source instance from a plurality of database clusters unified managed according to stored information on unified managed and registered data sources; C) obtaining a processing result of the target database by providing the parameter information to an structured operating instruction engine of the target database for processing; and D) converting the processing result set of the target database into a data set with a uniform format recognizable to the application unit. Thus, a coupling between the application project unit and the database can be weakened.

### FIELD OF THE INVENTION

The present invention relates to data integration and data processing technologies and in particular to an implementation method and system of an integrated interface supporting operation on multi-type databases.

### BACKGROUND OF THE INVENTION

In an enterprise-level network environment, coexistence of heterogeneous databases becomes more and more common. For example, a system with high concurrent requirements uses a low-cost cluster database system, and a system of high-level security requirement uses an expensive and high security large database system. Simultaneous application of heterogeneous databases is common in many system integration solutions and implementations. Thus, in the development of middleware for a system, how to connect respective heterogeneous databases and conduct development is a concern. Currently, various kinds of middleware developers use pre-defined multiple data sources, and then switch to different data sources for data operations in accordance with needs of application.

However, there are two problems with the above technique. Firstly, it is necessary to package operation commands for respective heterogeneous data sources, which greatly increases the amount of coding and the work load. Secondly, it is necessary for developers to have certain knowledge about each of heterogeneous data sources in order to ensure the quality of coding and the system.

### SUMMARY OF THE INVENTION

The present invention intends to solve one or more of the above problems by providing a Java-based and persistent operating tool supporting both MySQL and Oracle databases.

According to an aspect of the present invention, a method of implementing an integrated interface supporting operation on multi-type databases is provided, which comprises creating an integrated interface supporting multi-type data source operations, and implementing functions of the integrated interface through the following steps to provide application units with a unified access entry to multiple type databases: A) receiving parameter information comprising a data source instance, a data table entity model and operating instructions issued from an application unit; B) finding a target database of the data source instance from distributed database clusters comprising a plurality of databases under unified management for a supported data source type according to stored information on unified managed and registered data sources; C) providing the parameter information to a structured engine for operating instructions of the target database for processing to obtain a processing result of the target database; and D) converting the obtained processing result set of the target database into a data set having uniform format recognizable by the application unit, and then outputting the converted data set to the application unit.

Data sources that can be supported in the above method may comprise MySQL and Oracle. Thus, the application unit can conduct data operations on a variety of databases via the integrated interface.

In some embodiments, step C may comprise: finding a data table from the target database according to a provided data table entity model; operating on the data table in accordance with the operating instructions to obtain a processing result set. Thus, the structured operating instruction engine of the target database can parse the entity type parameter to generate the corresponding SQL for data processing.

The parameters may also comprise a condition entity option, then step C) may comprise: finding a data table from the target database based on a provided data table entity model; using the condition entity for further screening out data of the data table; operating on the screened corresponding data table in accordance with the operating instructions to obtain a processing result set. Thus, the criteria for screening target data can be flexibly controlled at the application layer to achieve better program extensions as necessary.

According to the present invention, application units apply “pseudo XSQL” as a unified format for data sets, with which the application units can perform operations on the target database directly without knowing the type of database in advance. “Pseudo XSQL” is a unique database manipulation language applied in the present invention, with its prototype referring to conventional “XSQL” for realizing an extensible structured query. An interpretation on the data set with “pseudo XSQL” format will be given as follows.

XSQL is a large and flexible Oracle database operation language with which developers can perform operations on the database, or even execute PL/SQL block. Because of its flexibility, XSQL is widely used in Oracle database development field. However, XSQL is provided to (Oracle) database field only. Pseudo XSQL is to break the boundary of this field, such that XSQL language can be applied to a wider range of database fields. Pseudo XSQL uses DOM4j technology to construct query result sets as respective parameters, then return the parameters to parameter nodes, and finally use “request” as the root node for packaging so as to form data sets in XSQL (xsql: request) format. Therefore, prototype of pseudo XSQL refers to XSQL, but it only supports a one-way output which is sent back to the client end through a server, and does not fully comply with the bidirectional input and output standard of XSQL. Thus, it is called “pseudo XSQL” in the present invention. Achieving this one-way standard is sufficient to enable developers at client end to directly use data of xstl or xml format to write the front page, without necessity of cycling the traditional results set and traversing, interpreting and rendering webpage data.

In addition, the present invention provides an integrated interface system supporting operation on multi-type databases, comprising: an application unit, an integrated interface and an integrated system. The application unit comprises a data processing module for setting parameter information comprising a data source instance, a data table entity model and operating instructions; and performing database operations by invoking the integrated interface. The integrated interface comprises a function module for operating on multi-type data sources and provides a unified access entry for database operations of the application unit. The integrated system is configured to implement function modules in the integrated interface, which comprises an information intercept module configured to receive parameter information comprising a data source instance, a data table entity model and operating instructions passed in from the application unit, a unified database management center comprising a data source screening module configured to find out, for a supported data source type, a target database of the data source instance from a plurality of distributed database clusters which are unified managed according to stored information on unified managed and registered data sources, a database processing module configured to provide the parameter information to a structured operating instruction engine of the target database to obtain a processing result set of the target database, and then output to the application program unit, an independent storage medium configured to store the registered data source information and at least one data source; and a data conversion module configured to convert the obtained processing result set of the target database into a data set having a uniform format recognizable to the application unit.

In some embodiments, the database processing module may comprise a data table mapping unit configured to find a corresponding data table in the target database based on the provided data table entity model, a data operation unit configured to operate the corresponding data table in accordance with the operating instructions to obtain the processing result set. Accordingly, the structured operating instruction engine of the target database can parse the entity type parameter to generate the corresponding SQL for data processing.

In some embodiments, the parameters issued by an application unit may also comprise a condition entity option, and the database processing module may comprise condition entity, the database processing comprises a data table mapping unit configured to find out a corresponding data table from the target database according to the provided data table entity model, a data screening unit configured to incorporate a condition entity for further screening data of the corresponding data table, and a data operation unit configured to operate corresponding data table after being screened in accordance with the operating instructions to obtain a processing result set. Thus, the criteria for screening target data can be flexibly controlled at the application layer to achieve better program extensions as necessary.

With the method and system described above, it is only necessary for an application unit to simply access the integrated interface according to data access requirements to obtain required data processing results, without a separate configuring and individual access to each data source in the application unit, which weakens a coupling between application project units and the databases and facilitates decoupling of the projects, thus providing a flexible extension. Meanwhile, a high requirement on developers′ knowledge of database can be eliminated, which facilitates them to pay more attention to transaction models.

### BRIEF DESCRIPTION OF THE DRAWINGS

FIG. 1 is a diagram of an integrated interface system being capable of supporting operation on multi-type databases according to an embodiment of the present invention;

FIG. 2 is a flow diagram of an implementation method of the integrated interface being capable of supporting operation on multi-type databases according to an embodiment of the invention.

### DETAILED DESCRIPTION

The present invention will be further described in detail in conjunction with the accompanying drawings as follows. The following description provides specific details for a thorough understanding and an enabling description of these implementations. A skilled in the art will understand that the invention may be practiced without some details disclosed herein. Moreover, some well-known structures or functions will not be illustrated or described to their details to avoid unnecessarily obscuring the substantive features which are embodied in the relevant description of various implementations. Furthermore, the terminology used throughout the whole description is intended to be interpreted in its broadest reasonable manner, though it may be used in conjunction with certain specific embodiments of the invention.

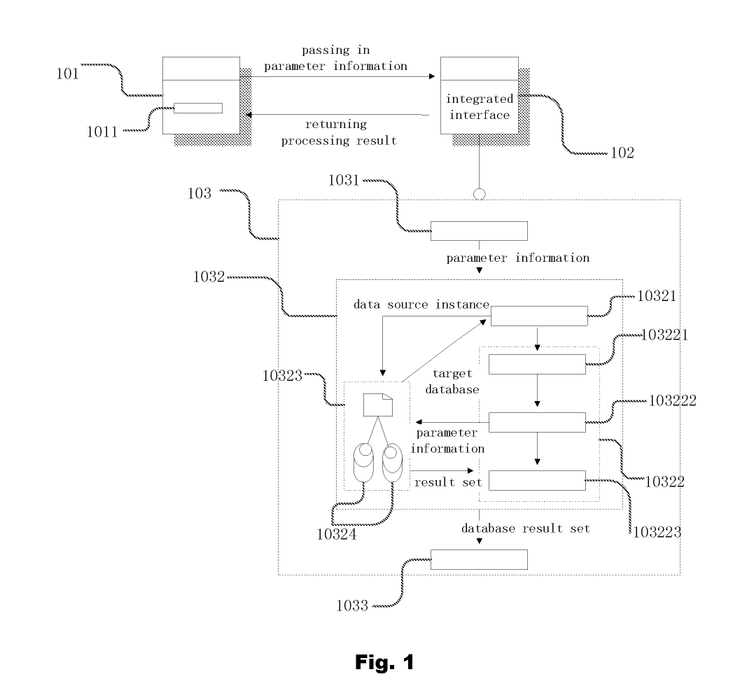

FIG. 1 schematically shows an integrated interface system being capable of supporting operation on multi-type databases according to an embodiment of the present invention. As shown in FIG. 1, the system comprises an application unit 101, an integrated interface 102, and an integrated system 103.

The application unit 101 can be embodied in a special purpose computer or data processor that is specifically programmed, configured, or constructed to perform one or more of the computer-executable instructions explained in detail below. Indeed, the terms “computer” or “computing system” as used generally herein, refer to devices that have a processor and non-transitory memory, like any of the above devices, as well as any data processor or any device capable of communicating with a network. Data processors may include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described below may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the art will recognize that portions of the invention may reside on a server computer, while corresponding portions reside on a client computer. Data structures and transmission of data particular to aspects of the invention are also encompassed within the scope of the invention.

Integrated interface 102 provides a unified entrance for performing operations on multi-type data sources the external through a database operation module set and defined therein. Integrated system 103 provides practical processing solutions for the database operating module of the integrated interface 102. Application unit 101 conducts operations on the database of data source by invoking the database operating module of integrated interface 102 and using processing solutions provided by integrated system 103.

As shown in FIG. 1, integrated system 103 includes an information interception module 1031, a unified database management center 1032 and a data conversion module 1033.

Information interception module 1301 uses “Spring” transaction management to intercept parameter information passed in from application unit 101, such as a data source instance, a data table entity model and operating instructions, and provides the parameter information to unified database management center 1032.

Unified database management center 1032 comprises a data source screening module 10321, a database processing module 10322, an independent storage medium 10323 and at least one data source 10324. Information of the registered data source 10324 is stored in the independent storage medium 10323 so as to put information of a plurality of same or different types of registered data source 10324 under unified management to provide database services to the external. Compared with the traditional way of one configuration file for one data source, the present application conduct a unified management which stores all information of a number of different types of data sources in the independent storage medium 10323. Thus, operations on database can be performed by merely matching the corresponding types of data sources through the unified data source management center 1032.

In the above manner, the unified database management center 1032 uses an independent storage medium 10323, i.e., a cache media independent of the database cluster instead of an existing database as a storage medium. Therefore, the unified database management center can perform management function for databases independently from databases′ own storage function, thereby avoiding confusion of database function and reducing the difficulty of design in respect of self-maintenance mechanism.

Data source screening module 10321 determines whether a data source instance corresponds to the registered data source information stored in the independent storage medium 10323 of the unified management center 1032 in accordance with the invoked address of the data source instance. If it is a registered data source, namely a supported data source, then a target database corresponding to the data source instance will be found from the stored registered data source 10324, and database processing module 10322 is started. Database processing module 10322 comprises a data table mapping unit 103221, a data screening unit103222 and a data operation unit 103223. Data table mapping unit 103221 finds a corresponding data table from the target database according to the mapping relationship between the data table entity model and the data table. Data screening unit 103222 sets the screening condition for the data in the data table in accordance with a condition entity. Data operation unit 103223 processes the operation instructions for the target database. Accordingly, the target database can parse the parameter information into SQL and execute it to obtain a processing result set of the target database by invoking the structured operating instruction engine.

Application unit 101 comprises a data processing module 1011. When it is necessary to perform database operations, application unit 101 only needs to set information on the data source instance, the data table entity model, the condition entity and the operating instructions in data processing module 1011 to set an integrated interface 102 to be invoked, a target database to perform data operations and database operating instructions to be executed. Then the data operations can be performed and data processing results can be obtained based on the settings of the data source instance, the data table entity model, the condition entity and the operating instructions by directly invoking the database operating module of the integrated interface 102.

For example, in this embodiment, assuming that an integrated interface named AladdinDataCenter is created for providing a unified entry service of database operations for the application unit 101, the following instances are defined in a data source instance configuration file of the application unit 101, and the data source instance is associated with integrated interface 102 via a “serviceInterface” property:

<bean id=“DBEnter”

class=“org.springframework.remoting.httpinvoker.HttpInvokerProxyFactoryBean”>

<property name=“serviceUrl” value=“${httpinvoker.ucenter.url}/aladdinDataCenter”/>
<property name=“serviceInterface” value=“xxx. AladdinDataCenter”/>

</bean>

Application unit 101 enters the data source instance into data processing module 1011 in the following ways:

@Resource(name=“DBEnter”)
publicAladdinDataCenterdbEnter;

When performing database operations through the data source instance “dbEnter”, the associated integrated interface “AladdinDataCenter” defined in the configuration file is used by default for database access.

Meanwhile, assuming that a table named “ucenter_access” is defined in the database to which the data source instance corresponds, application unit 101 defines in data processing module 1011 the entity model of the data table in the following manner:

@AladdinTable(name = “ucenter_access”)
public class Access {...}
Access ac = new Access( );

Thus, in application unit 101, the operations on the data table will be converted to the operations on the data entity, which can release pressure of developers for processing tedious data in the application development.

After that, according to the operating instructions required for a database, the data source instance can invoke an integrated interface 102 named AladdinDataCenter in this case according to the configuration of the “serviceInterface” property, thereby realizing the data processing operations of the data table named “ucenter_access” in the target database to which the data source instance corresponds. Thus, it is not necessary for application unit 101 to know the type of data sources or to conduct a configuration for database connection. It is only necessary to define a data source instance associated with the integrated interface 102 (for example, AladdinDataCenter) in the data source instance configuration file for implementing database operations by entering the data source instance into the data processing module 1011. The operation process is carried out by integrated system 103 which achieves integration interface 102. Application unit 101 only invokes integrated interface 102 without concerning the specific implementation process. For example, when it is necessary to access a database, dbEnter can call the integrated interface AladdinDataCenter through the operating instruction “insert: dbEnter.insert (ac)” to insert a new data entity “ac” into a corresponding data table named “ucenter_access” in the target database to which the data source instance corresponds.

Further, it is possible to set a screening condition for data in the table according to data requirements of the application unit 101, as will be described below.
Creating a condition entity: DataConditions condition= new DataConditions ( );

According to users' data requirements, i.e., the requirements of the application unit, adding the following screening condition:

condition.setNamed(true);
condition.setPage(page);
condition.setSize(size);
condition.addSort(“sort”, DataOrder.ASC);
condition.getConditionKeys( ).add(“userId=:userId”);
condition.getConditionKeys( ).add(“appId=:appId”);
condition.getConditionKeys( ).add(“roles=:roles”);
condition.getConditionParams( ).put(“userId”, ac.getUserId( ));
condition.getConditionParams( ).put(“appId”, ac.getAppId( ));
condition.getConditionParams( ).put(“roles”, ac.getRoles( ));

Setting a conditional entity for the data source instance: dbEnter.setConditions=condition;

Then, with the data source instance's invoking of the corresponding integrated interface 102 through operating instructions, application projects unit 101 can carry out database operations. For example, when it is necessary to query a database, the operation instruction “query” is used to invoke the query function of the integrated interface 102: List<Account>ds=dbEnter.query (ac). Thus, application unit 101 can obtain a returned data set “ds” in a recognizable format which meets the setting content of the data source, the data table entity model, the condition entity and the operating instructions information. Detailed of the above processing is not known and also not necessary to be known to the application unit (or project) 101. Therefore, through the provided integrated interface 102, decoupling of application unit 101 from the database is achieved. It is not necessary for developers to have a rich knowledge in database field, whilst the data processing requirements can be met through invoking the provided interface.

When application unit 101 calls the integrated interface 102 via dbEnter.query (ac), integrated interface 102 automatically finds integrated system 103 implementing its interface method. The information interception module 1031 of the integrated system 103 intercepts a data source instance “dbEnter”, a data table entity model “ac”, a condition entity “condition” and an operating instruction information “query” which are set according to the application requirements in the data processing module 1011 of the application unit 101 through “spring” transaction management, and provides these parameter information to the unified database management center 1032 for a data source type match and database processing. Data source screening module 10321 checks whether it is a database service provided by the unified database management center 1032 to the external according to a value of serviceUrl of the data source instance dbEnter, i.e., whether it is a registered data source 10324 stored in the storage medium 10323. If yes, the data source type to which the data source instance dbEnter corresponds has been registered, i.e., it is a supported data source. Then, a corresponding target database can be found according to serviceUrl and the name of the database in the registered data source information of the unified management center 1032. Then, the database processing module 10332 submits “ac” to the data table mapping unit 103221 to find the corresponding data table in the target database according to the mapping relationship between the data table entity model and the data table. “condition” is submitted to the data screening unit 103222 to set a screening condition for the data in the data table according to the condition entity. A query instruction is submitted to the data operation unit 103223 to determine operation processing for the target database. Therefore, an operating instruction structured engine of the target database parses the parameter information to a corresponding SQL statement and executes it, thus obtaining a processing result meeting “condition” in the data table named ucenter_access corresponding to the data table entity model “ac”.

Then, data conversion module 1033, by using DOM4j technology, constructs the queried processing result set as respective parameters and returns them to the “parameters” node. Finally, “request” is used for a root node packaging to form a data set in XSQL (XSQL: request) format to return to the application unit. For example, a result matching “ac” is found from the target database which has the following properties: the value of “lastname” field is dongwen, the value of “job” field is coder, and the value of “firstname” property is chen. Then, by using DOM4j technology, the query result is converted into the following format and returns to the application unit:

<request>
<parameters>
<lastname>dongwen</lastname>
<job>coder</job>
<firstname>chen</firstname>
</parameters>
</request>

Thus, application unit 101 can directly use xstl and xml to edit the front page, without cycling the traditional results set and traversing, interpreting and rendering web page data. In this way, the data prototype refers to XSQL, but only supports one-way output, i.e., from server back to a client end, which does not fully comply with the bidirectional input and output standard of XSQL, and thus is called as “pseudo XSQL” in the present invention.

From the above, integrated system 103 implements database operating module of the integrated interface 102, while it is not necessary for application unit 101 to care how integrated system 103 implements the database operations but only to use integrated interface 102 as an access entry to obtain the required data processing result. Thus, a coupling of the application project with the database is weakened. What developers need to do is to invoke defined interfaces without a requirement of rich knowledge on database.

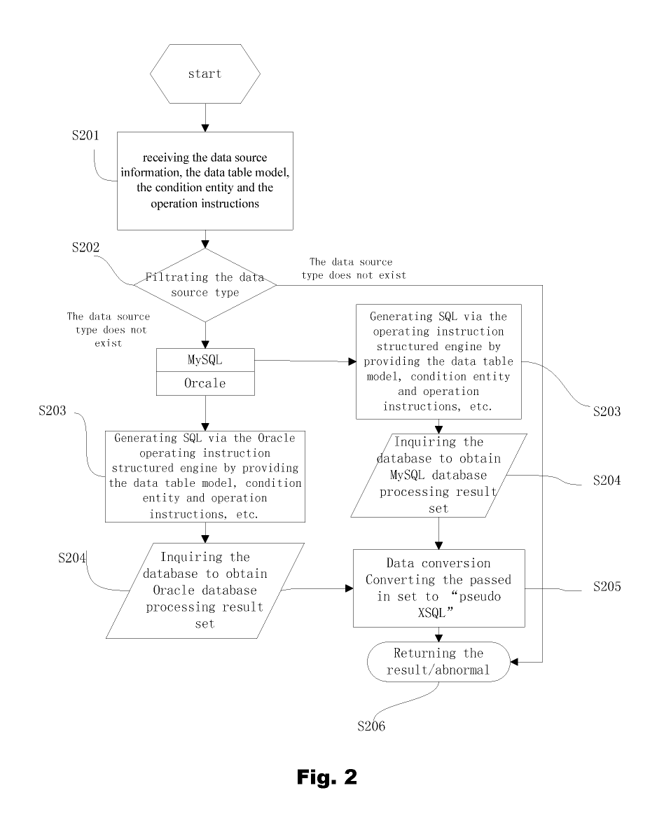

FIG. 2 is a flow diagram for the implementation method of the integrated interface supporting operation on multi-type databases according to an embodiment of the invention. As shown in FIG. 2, the method comprises the following steps:

S201: receiving parameter information comprising a data source instance, a data table entity model, a condition entity, the operation instructions and such parameter information passed in from an application unit.

It should be noted that the condition entity in the parameter information is optional. If it is not necessary for the application unit to set the condition for data screening, the value of the incoming condition entity is null. In this case, operations on the database are conducted directly according to the operating instructions to obtain the processing result, without a further screening of data in the data table.

S202: performing a data source type screening

It is determined whether the incoming data source instance is a type supported by the system according to the information of data sources registered in the unified data source management center. If there is not a data source type corresponding to the data source instance in the registered data source information list stored in the unified data source management center, then an abnormal information will be returned directly through the integrated interface to the application unit. On the other hand, if there exists a data source type corresponding to the data source instance in the registered data source information list stored in the unified data source management center, then a target database corresponding to the data source instance will be found from a plurality of distributed database clusters which are under a unified management and correspond to the data source type.

S203: generating SQL statement by the structured operating instruction engine of the target database.

Subsequent to finding of the target database, the unified data source management center will distribute the data table entity model, the condition entity and the operating instruction information to an instance target database. Then a SQL statement is generated by the structured database operating instruction engine of the target database. For example, if the data source type to which the data source instance corresponds is Oracle, then a structured operating instruction engine of the Oracle database parses the parameter information into a recognizable SQL statement. If it is MySQL, then a structured operating instruction engine of the MySQL database parses the parameter information into the SQL statement recognizable to MySQL.

S204: querying the target database to obtain the processing results set

The target database executes the generated SQL statement to obtain the processing results set and returns the processing results set to the integrated system for data conversion processing. When the target database executes the generated SQL statement, it will perform a data table reflection according to the table name described by the data table entity model and the association relationship of the table to find a corresponding data table which needs to be operated from the target database. Then a further screening for the data of the data table is conducted according to the contents of the condition entity so that the corresponding operations on the data table is carried out according to the operating instructions to obtain the processing results.

S205: data conversion

The integrated system receives the processing results of the “ResultSet” object returned by the target database, and then converts the results to XML format by using DOM4j technology to construct the query results set as respective parameters and returns them to the “parameters” node. Finally “request” is used as a root node to conduct a packaging so as to form a data set in XSQL (XSQL: request) format to be returned to the application unit. While XSQL is a conventional database operation language that is provided solely to the Oracle database field and complies with the bidirectional input and output standard, the data set in XSQL (XSQL: request) format formed in the present invention is a results set that supports only one-way outputs through the server back to the client end, which realizes extensible structured queries by referring to XSQL, and thus is called as “pseudo XSQL” in the present invention. Thus, developers of the client end can directly use data with xstl and xml formats to edit the front page, without cycling the traditional results set and traversing, interpreting and rendering the web page data.

S206: returning the converted data set as a returning result

Subsequent to the data conversion, the data set with “pseudo XSQL” format recognizable to the application unit can be obtained. The integrated system will return the result to the application unit via the integrated interface for redisplaying or processing.

The integrated system implements the function of the integrated interface for operating various types of databases through the above steps 201 to 206 and provides services of supporting operation on multi-type databases to the application unit through the integrated interface. The integrated interface provides a unified access entry to the application unit to achieve the decoupling of the application unit from the database by automatically by invoking the implementation solution of the integrated system.

In practice, the application unit can access the integrated interface to pass data source instance, data table entity model, condition entity and operating instructions information by merely using a provided interface to inject the data source instance, creating a data table entity model according to a defined mapping relationship between the data entity and the data table name, setting a condition entity based on requirements of the application, and invoking necessary database operation instructions through the data source entity. Then the integrated interface can be accessed to pass in. The integrated interface, upon receiving the parameter information, invokes its bottom implementation system to perform the above steps 201 to 206 to obtain the returning result. Then the result will be submitted to the application unit for redisplaying or processing.

Accordingly, it is possible to directly perform operations on a target database without knowing the type of the database beforehand by generating an integrated interface which supports operations on various types of databases. That is, to enable a unified access to various types of databases by an application unit, it is only necessary to create an integrated interface with its functions implemented by the integrated system. It is not necessary for an application unit to care about the data source and the type of database or to perform a conversion for the processing result. Operations on data source, such as security alteration and performance alteration, etc., will not affect a normal running of an application unit. Thus, a coupling between the application project and the database is weakened, which facilitates the decoupling of projects, thus enabling a more flexible extension for an application unit and eliminating a high requirement on developers′ knowledge in database field.

The descriptions for the above embodiments are only some examples for the purpose of illustrating the conception of the present invention. One skilled in the art will readily appreciate that various variations and modifications can be made based on the understanding of the above embodiments and the inventive conception therein, which fall within the protection scope of the present invention.

Certain aspects of the invention are presented below in certain claim forms, but the applicant contemplates the various aspects of the invention in any number of claim forms. Accordingly, the applicant reserves the right to pursue additional claims after filing this application to pursue such additional claim forms, in either this application or in a continuing application.

We claim:

1. A method of implementing an integrated interface supporting operations on multi-type databases, comprising:
creating an integrated interface at a server supporting multi-type data source operations, and achieving functions of the integrated interface by a processor of the server through the following steps to provide application units with a unified access entry to multiple type databases,
A) receiving parameter information comprising a data source instance, a data table entity model and operating instructions issued from an application unit;
B) finding a target database of the data source instance from distributed database clusters comprising a plurality of databases under unified management for a supported data source type according to stored information on unified managed and registered data sources;
C) providing the parameter information to a structured engine for operating instructions of the target database for processing to obtain a processing result of the target database; and
D) using the processor to convert the obtained processing result set of the target database into a data set having uniform format recognizable by the application unit, and then outputting the converted data set to the application unit.

2. The method of claim 1, wherein the supported data source type comprises MySQL and Oracle.

3. The method of claim 1, wherein step C) comprises:
finding a corresponding data table by the processor from the target database based on a provided data table entity model; and
operating by the processor on the corresponding data table in accordance with the operating instructions to obtain the processing result set.

4. The method of claim 1, wherein the parameter information further comprises a condition entity, and step C) comprises:
finding a corresponding data table in the target database based on the provided data table entity model;
adding the condition entity for further screening data of the corresponding data table; and
conducting operations on the screened corresponding data table in accordance with the operating instructions to obtain the processing result set.

5. The method of claim 1, wherein the data set with uniform format recognizable to the application unit in step D is a data set with “pseudo XSQL” format.

6. An integrated interface system supporting operation on multi-type databases, comprising:
an application unit being loaded in a storage medium of a server and comprising a data processing module for setting parameter information comprising a data source instance, a data table entity model and operating instructions;
an integrated interface comprising a function module for conducting operations on multi-type data sources and providing a unified access entry for database operations of the application unit;
an integrated system, configured to implement functions of the integrated interface, comprising:
an information interception module configured to receive the parameter information passed from the application unit through an interface;
a unified database management center comprising a data source screening module, a database processing module, an independent storage medium and at least one data source, wherein,
the storage medium is configured to store information of the registered data source,
a data source screening module configured to find out, for a supported data source type, a target database of the data source instance from a plurality of distributed database clusters which are unified managed according to stored information on unified managed and registered data sources,
a database processing module configured to provide the parameter information to a structured operating instruction engine of the target database to obtain a processing result set of the target database, and then output to the application program unit, and
an independent storage medium configured to store the registered data source information and at least one data source; and
a data conversion module configured to convert the obtained processing result set of the target database into a data set having a uniform format recognizable to the application unit.

7. The integrated interface system of claim 6, wherein the supported data source type comprises MySQL and Oracle.

8. The system of claim 6, wherein the database processing module comprises:
a data table mapping unit configured to find a corresponding data table from the target database based on the provided data table entity model; and
a data operation unit configured to operate the corresponding data table in accordance with the operating instructions to obtain the processing result set.

9. The system of claim 6, wherein the parameter information further comprises a condition entity, the database processing comprises:
a data table mapping unit configured to find a corresponding data table from the target database according to the provided data table entity model;
a data screening unit configured to incorporate a condition entity for further screening data of the corresponding data table; and
a data operation unit configured to operate corresponding data table after being screened in accordance with the operating instructions to obtain a processing result set.

10. The system of claim 6, wherein the application unit uses a data set in “pseudo XSQL” format as a data set with uniform format.
